(19) United States
(12) Patent Application Publication
(10) Pub. No.: US 2012/0015098 A1
(43) Pub. Date: Jan. 19, 2012

(54) CARBON NANOTUBE BASED TRANSPARENT CONDUCTIVE FILMS AND METHODS FOR PREPARING AND PATTERNING THE SAME

(76) Inventors: Qian Cheng, Cary, NC (US); Mei Lu, Cary, NC (US); Bo Gao, Elon, NC (US); Jie Liu, Chapel Hill, NC (US); Shie-Heng Lee, Taipei City (TW); Yu-An Li, Zhongli City (TW)

(21) Appl. No.: 12/836,215

(22) Filed: Jul. 14, 2010

(51) Int. Cl. B05D 5/12; H01B 1/04; H01B 1/12

(52) U.S. Cl. 427/110; 252/511; 252/506; 977/742; 977/892; 977/932

(57) ABSTRACT

Carbon nanotube (CNT) based transparent conductive films and methods for preparing and patterning the same are disclosed. For example, CNT based transparent conductive films with controlled transmittance and conductivity and methods of preparing and patterning the same are provided. Methods of preparing a CNT ink for assembling on a transparent substrate to form a transparent conductive film is disclosed, the ink can include a desired ratio of CNT with polymer. The transparent conductive film can be patterned such that desired properties are exhibited.

### TECHNICAL FIELD

The present subject matter relates generally to carbon nanotube based transparent conductive films and methods for preparing and patterning the same. More particularly, the present subject matter relates to transparent conductive films comprising carbon nanotubes (CNTs) combined with various polymers and methods for preparing and patterning the same.

### BACKGROUND

Transparent conductive films have a wide range of applications, for example they can be used in displays, touch panels, solar cells and other optoelectronic devices. The films typically consist of a transparent substrate upon which a coating or film that is transparent and electrically conductive is disposed. Currently, the dominant materials used for transparent conductive films are indium tin oxide (ITO) based films. However, the ITO based transparent conductors have many limitations. For example, the cost of the ITO based transparent conductor is very high as the ITO coating process requires expensive vacuum sputtering equipment. In addition, ITO is a limited natural resource and the price of ITO has increased significantly in the past few years because of short supply. ITO based transparent conductive films also have poor mechanical durability. That is, the ITO based films are brittle and can break easily if subjected to stress, for example, to bending stress. In addition, ITO based transparent conductors are also yellowish in color, and have a fairly large value of b*. Three CIELAB coordinates L*, a*, and b* represent the lightness of a color. For example, L* yields a position between black and white wherein black has a value of L*=0 and diffuse white has a value of L*=100, although specular white may be higher. A second coordinate, a* indicates a position between red/magenta and green. Negative values of a* indicate green while positive values indicate magenta. The b* coordinate indicates a position between yellow and blue wherein negative values of b* indicate blue and positive values indicate yellow. An ideal transparent conductor should comprise a neutral color. Therefore, ITO based films are not suitable for use with next generation flexible devices such as flexible displays, flexible touch panels and flexible solar cells.

Tremendous efforts have been made in the past few years to develop alternatives to ITO based films at a reduced cost. Up until now, the most promising ITO alternatives comprise conductive polymers, metal nanowires and carbon nanotubes (CNTs). Transparent conductive films formed using such alternatives have demonstrated transparency and conductivity comparable to those formed using ITO based films. In addition, transparent conductive films using these alternatives exhibit superior mechanical durability compared with the ITO based transparent conductors. Compared with conductive polymers and metal nanowires, CNTs have a much higher mechanical strength and chemical stability. Accordingly, CNTs can produce more stable and robust transparent conductive coatings. The performance of transparent conductive films fabricated using CNTs depends greatly on the processes by which the coatings are made. A lower cost and well controlled process for fabricating the CNTs based transparent conductive coatings is in demand. As many applications require patterned transparent conductive films, an efficient patterning process for the CNTs based transparent conductive films is also desired.

Accordingly, it is desirable to provide efficient and economic carbon nanotube based transparent conductive films and methods for preparing and patterning the same. The present subject matter relates to such devices and methods, and it will become apparent from the subsequent detailed description and the appended claims, taken in conjunction with the accompanying drawings and background information.

### SUMMARY

In accordance with this disclosure, carbon nanotube based transparent conductive films and methods for preparing and patterning the same are disclosed. Such films can comprise a plurality of carbon nanotubes (CNTs). It is, therefore, an object of the present disclosure to provide economic fabrication and patterning methods for creating durable CNTs based transparent conductive films.

This and other objects of the present disclosure as can become apparent from the present disclosure are achieved, at least in whole or in part, by the subject matter described herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a cross-sectional view of one embodiment of a carbon nanotube based transparent conductive film according to the subject matter herein;

FIG. 2A illustrates a cross-sectional view of one embodiment of a carbon nanotube based transparent conductive film according to the subject matter herein;

FIG. 2B illustrates a cross-sectional view of one embodiment of a carbon nanotube based transparent conductive film according to the subject matter herein;

FIG. 2C illustrates a cross-sectional view of one embodiment of a carbon nanotube based transparent conductive film according to the subject matter herein;

FIG. 2D illustrates an exploded view of one area of a carbon nanotube based transparent conductive film according to FIG. 2C;

FIG. 3 illustrates a flowchart for a method for fabricating the carbon nanotube based transparent conductive film in FIG. 1 according to the subject matter herein;

FIG. 4 illustrates a flowchart of a method for fabricating the carbon nanotube based transparent conductive film as seen in FIG. 2, according to the subject matter herein;

FIGS. 5A-5D illustrate cross-sectional views of one embodiment of a patterned transparent conductive coating method according to the subject matter herein;

FIG. 6 illustrates a flowchart of a method for fabricating a patterned transparent conductive coating as seen in FIG. 5, according to the subject matter herein;

FIGS. 7A-7D illustrate cross-sectional views of one embodiment of a patterned transparent conductive coating according to the subject matter herein; and

FIG. 8 illustrates a flowchart of a method for fabricating a patterned transparent conductive coating as seen in FIG. 7, according to the subject matter herein.

### DETAILED DESCRIPTION

Reference will now be made in detail to possible embodiments of the present subject matter, one or more examples of which are shown in the figures. Each example is provided to explain the subject matter and not as a limitation. In fact, features illustrated or described as part of one embodiment can be used in another embodiment to yield still a further embodiment. There is no intention to be limited or bound by any theory presented in the preceding background or the following detailed description of the present subject matter. It is intended that the subject matter disclosed and envisioned herein covers any such modifications and variations.

As illustrated in the various figures, some sizes of structures or portions are exaggerated relative to other structures or portions for illustrative purposes and, thus, are provided to illustrate the general structures of the present invention. Furthermore, various aspects of the present subject matter are described with reference to a structure or a portion being formed on other structures, portions, or both. As will be appreciated by those of skill in the art, references to a structure being formed “on” or “above” another structure or portion contemplates that additional structure, portion, or both may intervene. References to a structure or a portion being formed “on” another structure or portion without an intervening structure or portion are described herein as being formed “directly on” the structure or portion.

Furthermore, relative terms such as “on”, “above”, “top”, or “bottom” are used herein to describe one structure's or portion's relationship to another structure or portion as illustrated in the figures. It will be understood that relative terms such as “on”, “above”, “top”, or “bottom” are intended to encompass different orientations of the device in addition to the orientation depicted in the figures. For example, if the device in the figures is turned over, structure or portion described as “above” other structures or portions would now be oriented “below” the other structures or portions. Likewise, if devices in the figures are rotated along an axis, structure or portion described as “above”, other structures or portions would now be oriented “next to” or “left of” the other structures or portions. Like numbers refer to like elements throughout.

Transparent conductive films described herein have transparent conductive coatings comprising carbon nanotubes (CNTs), which under appropriate conditions can be coated with predetermined polymers. Such polymers can comprise for example, surfactants and adhesion promoters. By coating the surface of the CNTs with the proper polymers, improved transmittance and conductivity can be achieved from a CNTs based transparent conductive film. Modifying the surface of the CNTs can greatly enhance the uniformity and stability of a suspension containing CNTs. As a result, improved performance of a transparent conductive film can be achieved. Such improvements can include for example, better conductivity, transmittance, uniformity, stability, environmental stability, and an improved electrical response time of the transparent conductive films.

The transparency of a film can be characterized by its light transmittance (for example, defined by ASTM D1003), that is, the percentage of incident light transmitted through the conductive film and its sheet resistance. In one embodiment of the subject matter disclosed herein, the transparent conductive film can have a total light transmittance of no less than about 88% and a sheet resistance in the range of about 400 Ohms/square. Sheet resistance is applicable to two-dimensional systems where the thin film is considered to be a two-dimensional entity. It is analogous to resistivity as used in three-dimensional systems. When the term sheet resistance is used, the current flows along the plane of the sheet, and not perpendicular to it. In another embodiment, the transparent conductive film can have a sheet resistance in the range of approximately 1 to 10¹⁰ Ohms/square. In this regard, the transparent conductive films can be used in various applications such as for example, flat panel displays, solar cells, touch panels, e-papers, anti-static films, and microelectronics.

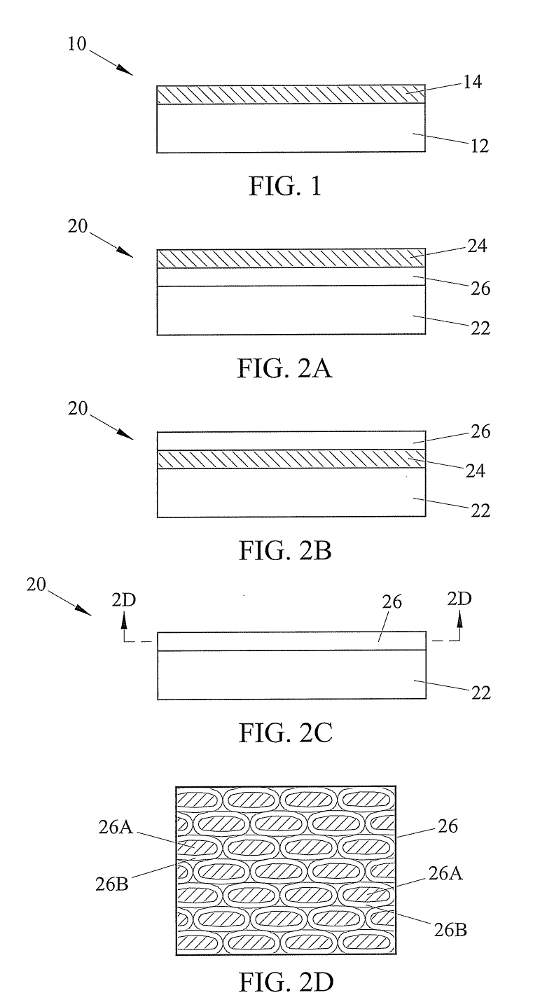

FIG. 1 illustrates a transparent conductive film generally designated 10. Transparent conductive film 10 can comprise a non-conductive, transparent substrate 12 having a CNTs based transparent conductive coating 14. The term “substrate” as used herein, includes any suitable surface upon which the compounds and/or compositions described herein are applied to or formed on. Transparent substrate 12 can comprise any rigid or flexible transparent material known in the art. The CNTs based transparent conductive coating 14 can comprise a plurality of CNTs that can be configured in a conductive network. The CNTs based transparent conductive coating 14 can comprise a coating of a CNTs based ink, discussed later below. The CNTs based ink can comprise an electrically conductive polymer disposed at least partially on a surface of the CNTs.

FIGS. 2A-2D illustrate another embodiment of a transparent conductive film, generally designated 20. Transparent conductive film 20 can comprise a non-conductive, transparent substrate 22, a first layer 24, and a second layer 26. The first layer 24 can comprise a CNTs based transparent conductive coating 24, and the second layer 26 can comprise a medium material 26. CNTs based transparent conductive coating can comprise a coating of a CNT ink discussed below. The CNT ink can comprise electrically conductive polymers which are disposed at least partially on the surface of the CNTs. Medium material 26 can comprise for example, a transparent adhesion promotion layer that may also comprise a second CNT ink. As illustrated in FIGS. 2A and 2B, the medium material 26 can either underlie or overlie the CNT based transparent conductive coating 24 that is disposed on the substrate 22. Alternatively as illustrated by FIGS. 2C and 2D CNTs 26A may be dispersed within the medium material 26. FIG. 2D is a close up view of medium material 26 in FIG. 2C, and can comprise one or more CNTs 26A having for example, a polymer coating 26B. The polymer coating 26B can comprise, for example, a surfactant or adhesion promoting material, and can be disposed on a surface of at least a significant portion of the CNTs 26A. In one embodiment, the polymer coating 26B can be formed on an entire surface of the CNTs 26A. The polymer coating 26B can comprise, for example, polyurethane (PU), polyvinylpyrrolidone (PVP), polyvinyl butyral (PVB), polyvinyl alcohol (PVA), Gum Arabic, Poly (3,4-ethylenedioxythiophene) (PEDOT), Triton X, and Silquest, used either alone or any combination/mixture of thereof.

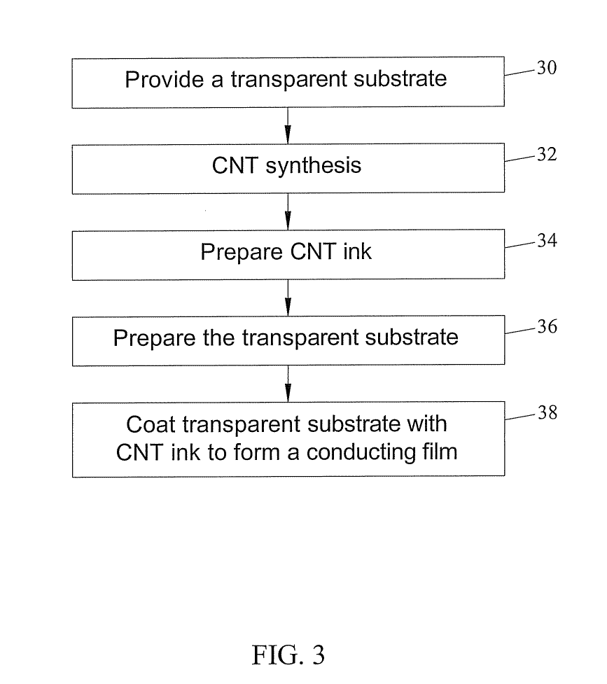

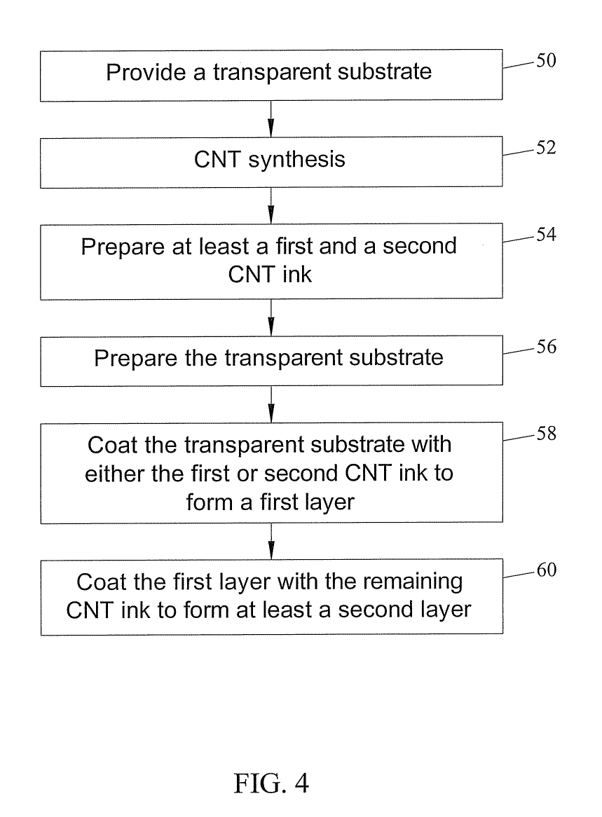

FIG. 3 illustrates a method for fabricating a CNTs based transparent conductive film, such as the transparent conductive film 10 in FIG. 1. FIG. 4 illustrates a method for fabricating a CNTs based transparent conductive film, such as the transparent conductive film 20 in FIGS. 2A-2C. The methods in FIGS. 3 and 4 can comprise initial steps 30 and 50, respectively, of providing a transparent, non-conductive substrate. The transparent, non-conductive substrates 12 and 22 can comprise any rigid or flexible transparent material known in the art. In one embodiment, transparent substrates 12 and 22 can have a total light transmittance of no less than 90%. Examples of transparent materials suitable for use as a transparent substrate include for example glass, ceramic, metal, paper, polycarbonates, acrylics, silicon, and compositions containing silicon such as crystalline silicon, polycrystalline silicon, amorphous silicon, epitaxial silicon, silicon dioxide (SiO₂), silicon nitride and the like, other semiconductor materials and combinations, ITO glass, ITO-coated plastics, polymers including homopolymers, copolymers, grafted polymers, polymer blends, polymer alloys and combinations thereof, composite materials, or multi-layer structures thereof. Examples of transparent polymers suitable for use as a transparent substrate include polyesters such as polyethylene terephthalate (PET), polycarbonate (PC) and polyethylene naphthalate (PEN), polyolefins, particularly the metallocened polyolefins, such as polypropylene (PP) and high-density polyethylene (HDPE) and low-density polyethylene (LDPE), polyvinyls such as plasticized polyvinyl chloride (PVC), polyvinylidene chloride, cellulose ester bases such as triacetate cellulose (TAC) and acetate cellulose, polycarbonates, poly(vinyl acetate) and its derivatives such as poly(vinyl alcohol), acrylic and acrylate polymers such as methacrylate polymers, poly(methyl methacrylate) (PMMA), methacrylate copolymers, polyamides and polyimides, polyacetals, phenolic resins, aminoplastics such as urea-formaldehyde resins, and melamine-formaldehyde resins, epoxide resins, urethanes and polyisocyanurates, furan resins, silicones, casesin resins, cyclic thermoplastics such as cyclic olefin polymers, styrenic polymers, fluorine-containing polymers, polyethersulfone, and polyimides containing an alicyclic structure.

In an alternative embodiment, transparent, non-conductive substrates 12 and 22 can optionally be pretreated to facilitate the deposition of components of the transparent conductive coating, discussed in more detail below, and/or to facilitate adhesion of the components to the substrate. The pretreatment can comprise, for example a solvent or chemical washing, exposure to controlled levels of atmospheric humidity, heating, or surface treatments such as plasma treatment, UV-ozone treatment, or flame or corona discharge. Alternatively, or in combination, an adhesive (also called a primer or binder) may be deposited onto the surface of the substrate to further improve adhesion of the components to the substrate.

In FIGS. 3 and 4, a further step in a method for fabricating a CNTs based transparent conductive film can comprise steps 32 and 52, respectively, comprising CNT synthesis, and can optionally comprise CNT processing steps and/or CNT functionalization. CNTs can be synthesized by using laser-ablation, arc-discharge, chemical vapor deposition (CVD), plasma enhanced chemical vapor deposition (PECVD) methods, or other suitable methods known in the art. Optional steps for processing CNTs can comprise for example, a purification process to remove catalysts, graphitic impurities, and/or amorphous carbon. An optional embodiment can comprise functionalized CNTs, that is, pre-treating the CNTs to facilitate their dispersion in a solvent. Functionalization processes comprise reacting CNTs with functional groups, for example strong oxidation agents such as HNO₃, H₂SO₄, H2O2, KMnO₄, NaOCl, and K₂Cr₂O₃ such that carboxyl groups or other oxygen-containing groups are added to the surface of the CNT thereby imparting a negative charge to the CNT. In accordance with the presently disclosed subject matter, negatively charging the CNT by acid treatment can enhance the electrostatic interaction between the CNT and the solvent. Reacting the CNTs with functional groups can thereby allow the CNTs to more easily disperse in liquids. The functional groups can physically or chemically attach to the CNTs without significantly changing other desirable properties of the CNTs. Through functionalization, a more uniform and stable coating suspension or ink can result in the transparent conductive films, and the films can exhibit improved properties such as, for example, improved conductivity, transmittance, uniformity, and stability.

Referring to FIGS. 3 and 4, further steps 34 and 54, respectively, in a method for fabricating a CNTs based transparent conductive film can comprise formation and preparation of at least one CNT ink. CNT inks can comprise a mixture of a first suspension with a second solution. For example, the first suspension can comprise a CNT dispersion wherein CNTs can be dispersed in a solvent having electrically conductive polymers. The second solution can comprise electrically conductive polymers with at least one other functional additive, described later below. Such functional additive can comprise for example, a high boiling-point solvent, an adhesion promoter, a wetting agent, and/or antioxidants. Both the first suspension and second solution can comprise electrically conductive polymers. The first suspension and second solution can be mixed to form a stable ink having a desired ratio of the CNTs and the polymer. Step 54 of FIG. 4 illustrates an embodiment wherein the method comprises formation of at least first and second CNT inks. The CNT inks can comprise CNTs having a polymer coating which can be formed for example, by using a selected concentration ratio of polymer to CNTs. The at least first and second CNT inks in FIG. 4 can comprise different CNT inks having different compositions with different ratios of CNTs and polymer. The inks can be coated to form multiple layers on the transparent substrate such as in FIGS. 2A and 2B. Multiple CNT inks having different compositions can be prepared to coat the transparent substrate to form multiple layers.

The CNT inks in steps 34 and 54 can comprise CNTs dispersed in a first solution comprising a solvent and polymer to form a stable suspension. The polymer in the CNT dispersion can comprise an electrically conductive polymer. The second solution which can mix with the CNT dispersion to form the CNT ink can comprise an adhesion promoter as a functional additive thereby forming transparent adhesion promotion layer upon coating the transparent substrate. In one embodiment, the CNT ink comprises a first CNT dispersion comprising at least one solvent, a polymer, and a plurality of CNTs, such as, for example, those CNTs available from Xintek, Inc. and XinNano Materials, Inc. The CNTs used in the ink dispersion can comprise an average thickness or diameter in a range from approximately 2 to 20 nm. The CNTs can comprise an average length in a range from approximately 0.1 μm to 100 μm. The CNTs can comprise approximately 1 ppm to about 4% by weight of the total ink. In a preferred embodiment, the CNTs comprise approximately 0.01 to about 0.6% by weight of the total ink.

The CNT dispersion component of the ink which comprises at least one solvent, a polymer, and a plurality of CNTs, can comprise any suitable solvent known in the art and can comprise any suitable pure fluid or mixture of fluids capable of forming a dispersion with CNTs. The CNT dispersion can be volatilized at a desired temperature, such as a critical temperature. Contemplated solvents can ideally be easily removed within the context of the applications disclosed herein. For example, contemplated solvents can comprise solvents having a relatively low boiling point as compared with boiling points of precursor components. In some embodiments, contemplated solvents comprise a boiling point of less than about 150° C. In other embodiments, contemplated solvents comprise a boiling point in a range from about 50° C. to about 250° C. This can allow the solvent to evaporate from the applied film. Suitable solvents comprise any single or mixture of water, alcohol and other organic, organometallic, or inorganic molecules that may be volatized at a desired temperature.

In other contemplated embodiments of the CNT dispersion component of the CNT ink, the solvent or solvent mixture can comprise aliphatic, cyclic, and aromatic hydrocarbons. Aliphatic hydrocarbon solvents can comprise both straight-chain compounds and compounds that are branched and possibly crosslinked. Cyclic hydrocarbon solvents are those solvents that comprise at least three carbon atoms oriented in a ring structure with properties similar to aliphatic hydrocarbon solvents. Aromatic hydrocarbon solvents comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosene, isobutylbenzene, methylnaphthalene, ethyltoluene, and ligroine.

In other contemplated embodiments, the solvent or solvent mixture for the CNT dispersion may comprise those solvents that are not considered part of the hydrocarbon solvent family of compounds, such as ketones (such as acetone, diethylketone, methylethylketone, and the like), alcohols, esters, ethers, amides and amines. Contemplated solvents may also comprise aprotic solvents, for example, cyclic ketones such as cyclopentanone, cyclohexanone, cycloheptanone, and cyclooctanone; cyclic amides such as N-alkylpyrrolidinone, wherein the alkyl has from about 1 to 4 carbon atoms; N-cyclohexylpyrrolidinone and mixtures thereof. Other suitable solvents can comprise methylisobutylketone, dibutyl ether, cyclic dimethylpolysiloxanes, butyrolactone, .gamma.-butyrolactone, 2-heptanone, ethyl 3-ethoxypropionate, 1-methyl-2-pyrrolidinone, propyleneglycol methyletheracetate (PGMEA), hydrocarbon solvents, such as mesitylene, toluene di-n-butyl ether, anisole, 3-pentanone, 2-heptanone, ethyl acetate, n-propyl acetate, n-butyl acetate, ethyl lactate, ethanol, 2-propanol, dimethyl acetamide, and/or combinations thereof. Other organic solvents can be used insofar as they are able to aid dissolution of an adhesion promoter (if used) and at the same time effectively control the viscosity of the resulting dispersion as a coating solution.

Still referring to steps 34 and 54 of FIGS. 3 and 4 respectively, the CNTs inks can optionally be mixed using any suitable mixing or stirring process that forms a homogeneous mixture. For example, a low speed sonicator or a high shear mixing apparatus, such as a homogenizer, a microfluidizer, a cowls blade high shear mixer, an automated media mill, or a ball mill, may be used for several seconds to an hour or more, depending on the intensity of the mixing, to form the dispersion. The mixing or stirring process can result in a homogeneous mixture without any substantial damage or change in the physical and/or chemical integrity of the CNTs.

In addition to the CNTs dispersion component of the CNT ink, a second solution contemplated in step 54 can optionally become mixed with the CNT dispersion to form a stable CNT ink. The second solution can comprise a mixture of the electrically conductive polymer and one or more functional additives. Examples of such functional additives can include one or more the following: a high boiling-point solvent known in the art which can improve the conductance of the film made from the CNT ink, dispersants and/or surfactants as known in the art which can help disperse CNTs uniformly, polymerization inhibitors and/or corrosion inhibitors known in the art which can improve the environmental and chemical stability, light stabilizers known in the art which can improve UV stability, wetting agents known in the art which can lower the surface tension of the inks, adhesion promoters known in the art which can be in a solution such as alcohol and/or binders known in the art which can increase the adhesion between the inks and substrates, antioxidants which can be in a solution, such as reducing agents thiols, ascorbic acid, and polyphenols, or other antioxidants known in the art which can prevent the films from oxidation, antifoaming agents known in the can prevent the inks from generating bubbles during coating, detergents, flame retardants, pigments, plasticizers, thickeners, viscosity modifiers, rheology modifiers, and photosensitive and/or photoimageable materials all of which are known in the art can be functional additives. The uniformity and stability of the CNTs suspension, for example, the CNTs ink dispersion, can be further improved by processing the mixed suspension with a centrifuge to remove large particles or aggregates that are not well dispersed in the suspension.

The method for fabricating a CNTs based transparent conductive film can continue as noted in steps 36 and 56 of FIGS. 3 and 4, respectively, by preparing the transparent substrate. Prepared transparent substrates are generally commercially available. The method can continue by coating the transparent substrate with the CNT ink to achieve a selected thickness and to form a first layer. This is seen as step 38 in FIG. 3 wherein the CNT ink can comprise a CNT based conductive film coating such as 14 in FIG. 1. In FIG. 4, one of the first or second CNT inks can be applied to coat the transparent substrate as illustrated by step 58, and can optionally comprise an adhesion promoter to form a transparent adhesion promotion layer, such as for example, medium material 26 illustrated by FIGS. 2A-D. The first layer of coating can comprise an adhesion promotion layer to enhance the adhesion between the CNTs based transparent conductive film and the transparent substrate. After coating the transparent substrate with the CNT ink to form a first layer per step 38 and 58, the substrate with coating may then be subjected to optional post processing steps. For example, post processing steps can comprise, for example, a drying, evaporating, heating, or curing step.

As illustrated by FIGS. 2A-2B and step 60 of FIG. 4, the remaining CNT ink can then coat the CNT ink applied in step 58 to form a second layer on top of the first layer. The remaining CNT ink coating can comprise a layer of transparent conductive CNT film coating, such as for example, CNT based transparent conductive coating 24 illustrated by FIGS. 2A and 2B. The CNT inks can be applied in steps 38, 58, and 60 for example, by brushing, painting, screen printing, stamp rolling, rod or bar coating, ink jet printing, or spraying the dispersion onto the substrate, dip-coating the substrate into the dispersion, slot-die rolling or micro gravure rolling the dispersion onto the substrate, or by any other method or combination of methods that permits the dispersion to be applied uniformly or substantially uniformly to the surface of the substrate and known in the art. The CNT inks prepared in steps 34 and 54 can optionally be applied in one layer or in multiple layers having the same and/or different CNTs compositions with the same and/or different CNT/polymer ratios and/or the same or different functional additives. Each CNT ink can be coated to achieve a film having a desired thickness. As illustrated by FIG. 4, several suspensions having different concentrations of CNTs can be applied in an alternating manner to form, for example, double layer or multilayer structures. Upon coating the remaining CNT ink in step 60, the conducting film may then subjected to optional post processing steps.

Post processing steps, as previously mentioned can also further include evaporation of the solvent of the CNT dispersion such that the deposited CNTs are no longer mobile on the substrate. In another embodiment, the CNT dispersion may be applied by a conventional rod coating technique and the substrate can be placed in an oven, optionally using controlled air flow, to heat the substrate and dispersion and thus evaporate the solvent. In another example, the solvent can be evaporated at room temperature (15° to 27° C.). In one example, the dispersion can be applied to a heated substrate by spraying the suspension, the ink, onto the substrate at a coating speed that allows for the evaporation of the solvent. If the dispersion comprises a binder, adhesive, or other similar polymeric compound, then the dispersion also can also be subjected to a temperature or UV light that will cure the compound. The post-processing step of curing can be performed before, during, or after the evaporation process. The resultant conductive film can have a surface resistance of less than 2000 Ohms/sq when an optical transmittance of the conductive film excluding the transparent substrate is better than 95%.

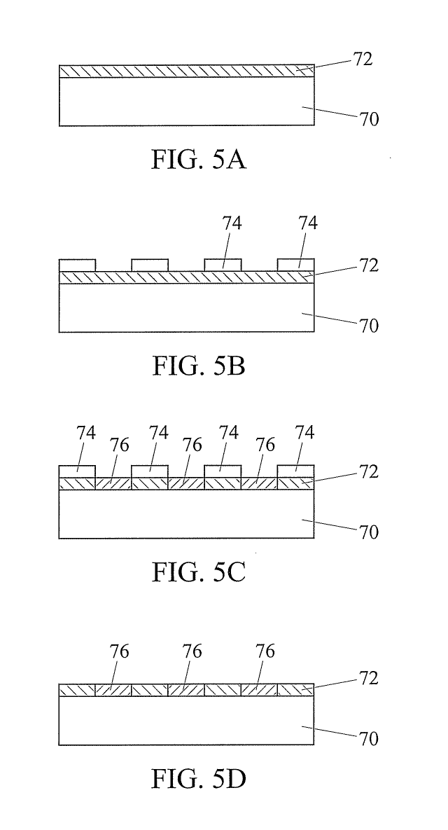

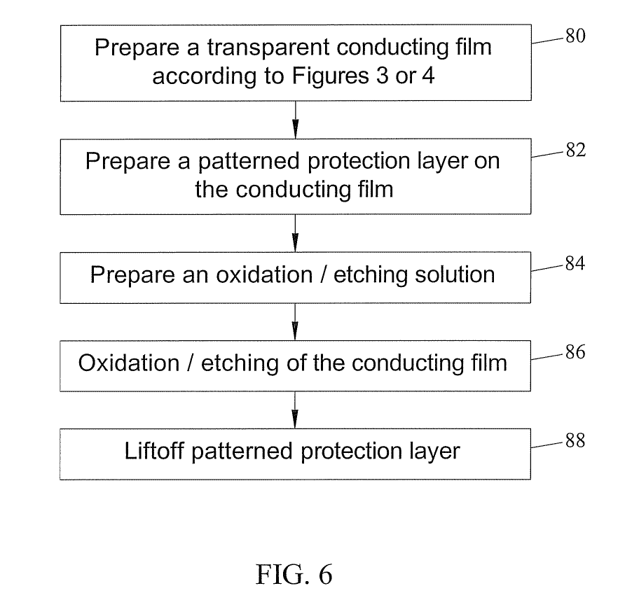

Referring to FIGS. 5A-5D and FIG. 6, a method for patterning a CNTs based transparent conductive film, such as the transparent conductive films of FIGS. 1 and 2A-D, is provided. Patterned transparent conductive films can be used, for example, for applications such as touch panel or other display applications known in the art. FIG. 5A illustrates preparation of a transparent, non-conductive substrate 70 having a CNT based transparent, conductive film 72 prepared as illustrated by step 80 in FIG. 6. The transparent conducting film can be prepared using a method identified in FIG. 3 or 4. The method can then further comprise step 82 of FIG. 6 and as illustrated by FIG. 5B, the step of preparing and covering a top surface of the transparent conductive layer 72 with a patterned protection layer 74. The protection layer 74 can comprise, for example, photo resist or any other printable resist known in the art. The patterns can be created for example, by using photolithography for photo resist or screen printing for printable paste. The patterned protection layer 74 can be cured by using UV light or an elevated temperature to ensure enough mechanical and chemical stability against the oxidation/etching solution and good adhesion to the substrate.

The method can further comprise step 84 in FIG. 6 of preparation of an oxidation/etching solution followed by an oxidation/etching step 86 of the conductive film using the oxidation/etching solution. As illustrated by FIG. 5C, the oxidation/etching step 86 causes unprotected, or exposed, areas to become oxidized/etched areas 76 of the conductive film layer. The patterned protection layer 74 can cover and protect selected areas of the conductive layer 72 from reacting with the oxidation/etching solution. The oxidation/etching solution can comprise for example, strong acid and/or base solutions such as HNO₃, H2SO₄, NaOH and KOH, or any other solution containing strong oxidation agents such as for example, NaOCl, KMnO₄, and K₂Cr₂O₃. The oxidation/etching time can range from a few seconds to a few hours depending on the composition and concentration of the oxidation/etching solution. The apparatus may then be subjected to optional post processing steps, such as for example, a cleaning and/or drying step.

As illustrated by FIG. 5D and step 88 of FIG. 6, after the oxidation/etching step and any optional post processing steps, the patterned protection layer 74 can be removed using liftoff or other method known in the art, and the patterned conductive film can be produced. The patterned conductive film can comprise a pattern formed from areas of CNTs based transparent conductive layer 72 and oxidized/etched areas 76 of the CNTs based transparent conductive layer. The protection layer 74 can be removed by specific resist remover for photoresist based protection layer and can be removed simply by mechanical force for protection layer based on printable paste. Before removal of the protection layer, the film can be cleaned and rinsed thoroughly using de-ionized water or alcohol to remove the residuals of the oxidation/etching solution. A photoresist suitable for the protection layer can comprise for example, SU8 from MicroChem Corporation and the printable resist suitable for the protection layer can comprise a strippable solder mask available from Asahi Chemical Research Laboratory Co., Ltd. In one embodiment, the transparent conductive film can also be patterned by replacing the wet oxidation/etching process as shown in FIG. 5 by a dry etching process. Such dry etching processes include for example, plasma, laser ablation, and UV Ozone processes.

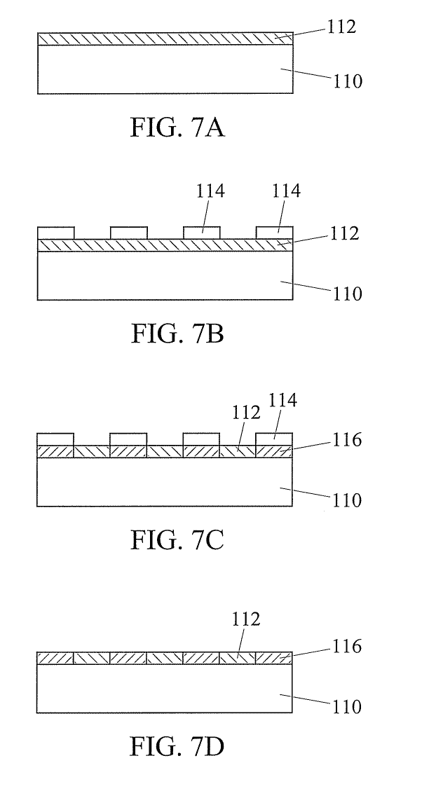

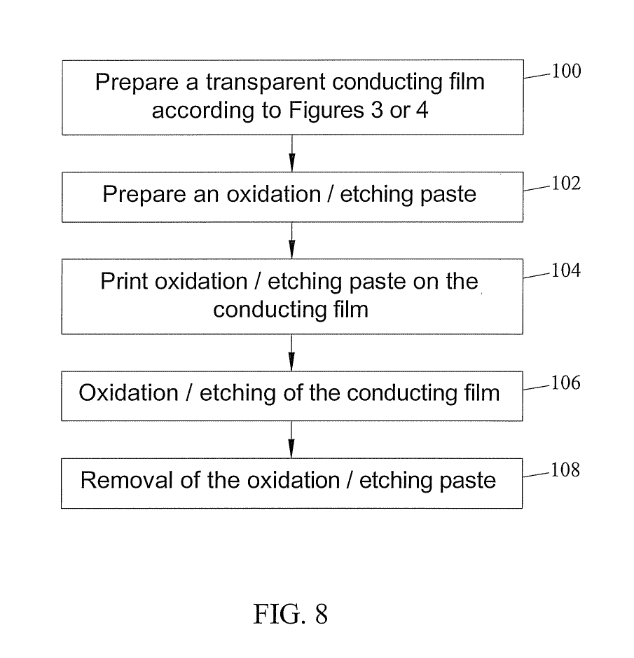

FIGS. 7A-7D and FIG. 8 illustrate another embodiment of patterning a CNTs based transparent conductive film, such as the transparent conductive films 10 and 20 of FIGS. 1 and 2A-C. An initial step 100 of preparing a transparent conductive film can be conducted. The transparent conducting film can be prepared according to the methods outlined in FIG. 3 or 4. FIG. 7A illustrates the transparent conductive film as comprising a transparent, non-conductive layer 110 having a CNT based transparent conductive layer 112. A second step 102 comprises preparing an oxidation/etching paste 114. The oxidation/etching paste 114 can undergoes a printing step 104 wherein it becomes printed on a top surface of selected areas of the CNT based transparent conductive layer 112. After printing, areas of the transparent conductive film covered by the oxidation/etching paste can become oxidized/etched per step 106 while uncovered or exposed areas of the film remain unchanged. The covered areas become oxidized/etched areas 116 and the unchanged areas of the CNTs based transparent conductive layer 112 can be seen in FIGS. 7C and 7D. The oxidation/etching paste can comprise screen printable pastes containing strong acids (for example, HNO₃ and H₂SO₄), pastes containing strong bases (for example, NaOH and KOH) and any other oxidation agents such as for example, NaOCl, KMnO₄, and K₂Cr₂O₃. Once the oxidation/etching step 106 is complete, the oxidation/etching paste can be removed per step 108 of FIG. 8.

Accordingly, CNT based transparent conductive films having transparent conductive coatings with controlled transmittance and conductivity and methods of preparing and patterning the same are provided. Embodiments of the present disclosure shown in the drawings and described above are exemplary of numerous embodiments that can be made within the scope of the appended claims. It is contemplated that the configurations of CNTs based transparent conductive films and methods of making the same can comprise numerous configurations and processing steps other than those specifically disclosed.

What is claimed is:

1. A method for generating a carbon nanotubes (CNTs) based ink for use with a transparent conductive film, the method comprising the following steps:
providing one or more CNTs;
dispersing the one or more CNTs in a first solution containing a polymer to form a stable suspension; and
mixing the suspension with a second solution containing the polymer and at least one functional additive to form a stable ink having a desired ratio of the CNTs and the polymer.

2. The method according to claim 1, wherein the polymer is an electrically conductive polymer.

3. The method according to claim 1, further comprising the step of reacting the CNTs with an oxidation agent to form functionalized CNTs.

4. The method according to claim 3, wherein the oxidation agent is selected from the group consisting of HNO₃, H₂SO₄, NaOCl, KMnO₄, and K₂Cr₂O₃.

5. The method according to claim 1, wherein the at least one functional additive comprises an additive selected from the group consisting of a high boiling point solvent, a wetting agent, an adhesion promoter, and an antioxidant.

6. The method according to claim 5, wherein the adhesion promoter is dispersed in alcohol.

7. The method according to claim 6, further comprising the step of reacting the CNTs with an oxidation agent to form functionalized CNTs.

8. The method according to claim 7, wherein the oxidation agent is selected from the group consisting of HNO₃, H₂SO₄, NaOCl, KMnO₄, and K₂Cr₂O₃.

9. The method according to claim 5, wherein the antioxidants are reducing agents selected from the group consisting of thiols, ascorbic acid, and polyphenols.

10. The method according to claim 1, further comprising the step of coating the ink on a transparent substrate to form a conductive film by using a technique selected from the group consisting of roll-to-roll processing, bar coating, and spraying.

11. The method according to claim 1, wherein the conductive film has a surface resistance less than 2000 Ohms/sq when an optical transmittance of the conductive film excluding the transparent substrate is better than 95%.

12. The method according to claim 1, wherein a second CNT ink is formed having a different ratio of the CNTs and the polymer than the first CNT ink.

13. A method of assembling a transparent conductive film onto a transparent substrate, the method comprising:
forming a carbon nanotubes (CNTs) ink comprising:
dispersing CNTs in a first solution having conductive polymers;
adding a high boiling-point solvent to a second solution having conductive polymers;
adding a wetting agent to lower a surface tension of the second solution;
dispersing an adhesion promoter in the second solution;
adding an antioxidant to the second solution;
adding the second solution to the first solution to form the CNTs ink; and
coating the transparent substrate with the ink to form a transparent conductive film, whereby coating is performed using a technique selected from the group of roll-to-roll printing, spraying, and bar coating.

14. The method according to claim 13, wherein the transparent conductive film has a surface resistance of less than 2000 Ohms/sq when optical transmittance of the transparent conductive film excluding the substrate is greater than 95%.

15. The method according to claim 13, wherein the substrate comprises a polymer.

16. The method according to claim 15, wherein the polymer comprises polyethylene terephthalate (PET).

17. A method of fabricating a flexible and adherent transparent conductive film with, the method comprising:
purifying pre-made carbon nanotubes (CNTs) to remove one or more of catalysts, graphitic impurities, and amorphous carbon;
dispersing the purified CNTs in a first solution comprising conductive polymers;
adding a high boiling-point solvent to a second solution;
adding a wetting agent to lower a surface tension of the second solution;
adding antioxidants solution to the second solution to improve the environmental stability of transparent conductive films;
adding an adhesion promoter to the second solution for improving adhesion of the solution;
adding the second solution to the first solution to form an ink; and
coating a substrate with the ink to form the transparent conductive film, whereby coating is performed using a technique selected from the group consisting of roll-to-roll printing, spraying and bar coating.

18. The method according to claim 17, wherein the transparent conductive film comprises an improved electrical response time.

19. The method according to claim 17, wherein the transparent conductive film comprises an improved environmental stability.

20. The method according to claim 17, wherein at least a first and a second CNT ink are formed.

21. The method according to claim 17, wherein the first and second CNT inks have a different first and second ratio of the CNTs and the polymer than the first CNT ink.

22. A method of fabricating a patterned carbon nanotube based transparent conductive film, the method comprising:
purifying pre-made carbon nanotubes (CNTs) to remove catalysts, graphitic impurities, and amorphous carbon;
dispersing the purified CNTs in a first solution containing conductive polymers;
adding a high boiling-point solvent to a second solution;
adding a wetting agent to lower a surface tension of the second solution;
dispersing an adhesion promoter in alcohol;
adding the adhesion promoter and alcohol to the second solution;
adding antioxidants to the second solution;
adding the second solution to the first solution whereby an ink forms;
agitating the ink for improved adhesion;
coating a substrate with the ink to form a conductive film, whereby coating is performed using a technique selected from the group consisting of including roll-to-roll printing, bar coating, and spraying; and
printing a paste containing a strong oxidizing agent to cover selected areas of a top surface of the conductive film thereby leaving exposed areas of the top surface of the conductive film.

23. The method according to claim 22, wherein the substrate comprises a polymer substrate.

24. The method according to claim 22, wherein the step of printing the paste comprises screen printing.

25. A method according to claim 22, further comprising the steps of:
oxidizing the selected areas of the conductive film; and
removing the cured paste from the conductive film.

26. A method of fabricating a patterned adherent carbon nanotube based transparent conductive film, the method comprising:
forming an ink comprising carbon nanotubes (CNTs) dispersed in a polymer solution;
coating the ink to a top surface of a substrate to form a conductive film, whereby coating is performed using a technique selected from the group consisting of roll-to-roll printing, bar coating, and spraying;
preparing a patterned protection layer;
applying the patterned protection layer to cover selected areas of a top surface of the conductive film thereby leaving exposed areas on the top surface of the conductive film; and
curing the patterned protection layer.

27. A method according to claim 26, further comprising the steps of:
oxidizing the exposed areas of the conductive film using an oxidizing solution; and
removing the patterned protection layer from the conductive film.

28. The method according to claim 26, wherein the substrate comprises a polymer substrate.

29. The method according to claim 26, wherein the patterned protection layer is prepared on a top surface using a screen printing technique.
